(19) United States
(12) Patent Application Publication
(10) Pub. No.: US 2024/0200366 A1
(43) Pub. Date: Jun. 20, 2024

(54) ADJUSTABLE OR FIXED VESA READY COUNTERTOP MOUNT WITH VISUALLY SCREW-LESS ASSEMBLY WITH OPTIONAL PORTABILITY AND SECURITY

(71) Applicants: Steven Wai-Tong Cheung, Plainview, NY (US); Sergio Portella Dealbuquerque, Plainview, NY (US)

(72) Inventors: Steven Wai-Tong Cheung, Plainview, NY (US); Sergio Portella Dealbuquerque, Plainview, NY (US)

(21) Appl. No.: 18/360,800

(22) Filed: Jul. 27, 2023

Related U.S. Application Data
(60) Provisional application No. 63/392,758, filed on Jul. 27, 2022.

(51) Int. Cl. E05B 73/00; A47F 5/04

(52) U.S. Cl. CPC E05B 73/0082; A47F 5/04

(57) ABSTRACT

An apparatus permitting VESA compliant devices to be mounted onto an adjustable, rotatable display is disclosed. The apparatus consists of a Mounting Plate, which can be affixed onto a desk; plus, a Stand Apparatus that can be secured together without the use of any externally visible hardware. A VESA Plate, which contains VESA-standards compliant mounting holes, is then installed onto the Stand Apparatus, with an optional Adjustable Adaptor. The hollow center of the apparatus allows easy cable management and hides wiring from view.

### FIELD

The disclosed subject matter relates generally to mounting devices, and more particularly to an adjustable or fixed VESA ready countertop mount with visually screw-less assembly with optional portability and security

### BACKGROUND

Typically, VESA ready mounting was featured only on devices such as monitors, televisions, and other large display devices, which allowed these displays to be affixed permanently and securely.

With the advent of compact, PC or tablet-based touch screen controls, interactive displays, and other touch-feedback digital signage, the VESA mounting standards spread to smaller devices, and many dedicated touch panel, tablet enclosures, point-of-sale devices, and other products now feature standard VESA mounting hole patterns.

However, with the rise of low-voltage, VESA-ready display solutions come new challenges, such as being able to power these devices using low voltage wiring, such as but not limited to USB or CAT5 networking cables, both of which can carry both power and data. These setups may incorporate some type of adapter or dongle which transform a single low-voltage line into power and data. Hiding, routing, and managing these wires becomes a challenge.

In addition, since these devices are being used more and more in customer-facing applications, the appearance or aesthetics of the devices have become increasingly important. Standard solutions based on flat, extruded surfaces and exposed wiring are not acceptable in many retail environments, thus necessitating the manufacture of more aesthetically pleasing designs that showcase rounded form factors, hidden mounting hardware, and other visually appealing features that blend into the setup.

Mounting products for tablets and electronic devices in the prior art, such as those in U.S. Pat. Nos. 9,395,037B2 and 10,368,462B2, address some of the hidden wiring, appearance, and aesthetics requirements, but in both cases, they require a custom-designed enclosure to be kitted along with the disclosed subject matter. This significantly increases the cost of the setup on a per piece basis, as this limits the marketability of the mount by itself—since it is incompatible for non-tablet devices.

Furthermore, if power charging or connectivity converters are required for the setup—such as, but not limited to, PoE Adapters—designs in the prior art, such as those in Patents U.S. Pat. Nos. 9,395,037B2 and 10,368,462B2, would force an installer to place any connected adapters outside of the design's protective housing—usually underneath the mounting surface. Once again, this deficiency increases each setup's cost, as the installer is now required to install an additional box hidden under the mounting surface to house the connectivity adapters, or risk exposing the setup's wiring to public access, and subjecting it to tampering as the connections are left exposed.

Therefore, using adjustable, aesthetic designs in the prior art will not always provide an optimal result, as it always results in one deficiency or another. These designs are often custom made to fit only select tablets or products, making them an invalid choice for unsupported tablets, non-tablet devices, or VESA-ready devices.

Other mounts in the prior art which allow wiring to be hidden often lack void space which allow additional connectivity components to be hidden inside of the disclosed subject matter, subjecting the installation to potential theft or tampering if no secured cabling boxes are installed underneath the mounting surface, or increasing each setup's cost for these additional components to secure the wiring.

There exists a need for an improved design that remains aesthetically pleasing, yet supports the vast array of VESA ready devices, while allowing its cables and connected components to remain protected from tampering.

### SUMMARY

The disclosed subject matter pertains to an apparatus which allows a VESA-ready device to be presented at a fixed or different viewing angle positions for easier interactive use. The apparatus can be permanently affixed and mounted on a flat surface by using one or more pieces of hardware, such as, but not limited to, screws that secure an optional mounting plate. p The design focuses on maintaining a clean aesthetic, such that the assembled pieces utilize a unique geometry to hide and cover all surface mounting screws from the primary user's view.

In practice, a growing number of displays—ranging from flat-panel monitors, TVs, specialized tablets, or most recently tablet enclosures, are becoming smaller and more personal for interactivity. The problem is now presented, where these devices may need to be placed onto a desktop, countertop, or wall, and be displayed at an angle for easy viewing.

This newly disclosed subject matter allows the use of any VESA-ready device to be easily displayed at a fixed or multiple viewing angle positions for easier viewing, with the setup being permanently fixed on a table or countertop with a fully secure design.

In a first aspect of the disclosed subject matter, an apparatus with a Mounting Plate is disclosed. The Mounting Plate runs parallel to the surface where the apparatus is expected to be placed and features a Unique Geometry to allow other parts to be assembled onto the Mounting Plate and be secured against removal, without the use of any external screws or other visible hardware. This allows the entire apparatus to be more aesthetic when fully assembled, since there are no hardware pieces visible to the primary user.

In one variant, the Mounting Plate can be manufactured with a beveled top that complements the geometry of the other aspects of the disclosed subject matter to be mated. This beveled top allows the other aspects of the disclosed subject matter to be moved into the correct initial position more easily, thus restricting 1 (or more) degrees of freedom. This feature may be highly desired when assembly speed is important, since without this variation, the parts can become difficult or time-consuming to align correctly. A beveled top can aid in the initial alignment to guide the parts to be coaxial, if the final or proceeding installation movement is a rotating motion; collinear, if the installation movement is a straight linear motion; or coincident, if the installation movement is a curved spline shaped motion.

In another variant, the Unique Geometry can be designed to provide quick, intuitive visual feedback to an installer, without the use of any additional tools, when other aspects of the disclosed subject matter are to be assembled onto the Mounting Plate. After the other aspects of the disclosed subject matter are placed in the proper initial alignment position, the installer can move the part along a straight or curved direction (on collinear or coincident setups, to eventually reach a point that restricts the 2 remaining degrees of freedom, or rotate the part (on coaxial setups with only 1 remaining degree of freedom) into the final resting, secured position. When moved or rotated in the correct installation orientation, the other aspects' bottom surface would be drawn closer to the Mounting Surface (such as a table or desktop). Thus, the installer can quickly see the gap closing between the bottom of the other aspects of the disclosed subject matter and the top of the Mounting Surface. When the two surfaces finally sit flush it confirms that the assembly is now complete. This visual feedback provides positive confirmation that the other aspects of the disclosed subject matter have been moved to the correct final installation orientation. On the other hand, if the other aspects of the disclosed subject matter are moved away from the correct installation orientation and towards an incorrect direction, the Mounting Plate's Unique Geometry would push those parts away from the Mounting Surface, clearly indicating that the present motion is going in the wrong direction, as the visible gap between the parts gets wider.

In yet another variant, a screw, rivet, or other pattern consisting of one or more holes—a.k.a. Mounting Pattern—is located on the top of the Mounting Plate to allow the use of mechanical fastening hardware to affix it to the Mounting Surface, to fully secure and affix the disclosed subject matter when assembled.

In yet another variant, the Mounting Pattern is replaced by one or more Recessed Surfaces, located at the underside of the Mounting Plate. This Recessed Surface is optimized to match the thickness of double-sided tape, epoxy, or other included components used to affix the Mounting Plate to the Mounting Surface, while allowing the entire bottom surface of the Mounting Plate to stay flush with the Mounting Surface. Without this Recessed Surface, the materials' thickness may offset the installed height of the Mounting Plate, unintentionally minimizing its contact area with the Mounting Surface, thus potentially compromising the security of the installation.

In yet another variant, the Mounting Plate features a Retaining Clip, which is a protrusion located near the Mounting Plate's outer circumference or other outer surface, such that other parts can be moved or slid over this Retaining Clip during assembly, allowing all pieces to be securely locked into place.

In yet another variant, the Retaining Clip can be spring-loaded or otherwise made retractable, such that it can be actuated with a tool to forcibly compress the spring or other retracting mechanism. In a fully compressed state, the Retaining Clip is pushed sufficiently away from the circumference and/or towards the Mounting Plate's center. This motion is sufficient to allow the other aspects of the disclosed subject matter—previously secured by the Mounting Plate's Retaining Clip—to be freed and allow disassembly.

In yet another variant, the Mounting Plate can be made of two or more different materials that are mechanically fastened, physically pressed, chemically adhered, or otherwise laminated with respect to each other. For example, the primary Mounting Plate piece can be made of plastic, PLA, or other low-cost material, while other parts that need to be more durable—such as the Retaining Clip—are made of metal. This choice of different materials may provide a significant increase to the theft-deterrence of the assembly in preventing unauthorized removal.

In yet another variant, one or more optional Thru Holes can be located at any reasonable location on the Mounting Plate.

In yet another variant, the Mounting Plate's optional Thru Hole can be centered on the Mounting Plate. This minimizes any potential for cables to become entangled should other components installed be adjustable or allow rotation about the center of the Mounting Plate.

In a second aspect of the disclosed subject matter, a Stand Apparatus is disclosed. This Stand Apparatus's design is unique, where instead of using traditional, mechanical fasteners or adhesives for assembly; a Reciprocating Geometry is manufactured into the bottom surface of the Stand Apparatus that works in concert with the Unique Geometry built into the Mounting Plate to secure these two (2) parts. The assemblage is affixed with no externally visible or exposed screws required. Once assembled, the Mounting Plate will retain and hold the Stand Apparatus in a fixed, secured position, thus preventing unauthorized removal.

In another variant, the Stand Apparatus can be manufactured with a Hollow Core. Installers can utilize this void space to run power, data, input-output, and other wiring and cables—passing them from the top of the Stand Apparatus, into the part's Hollow Core, then exit out of a through hole on the Mounting Surface. The Hollow Core can also house any connectivity and/or charging power adapters, and guarantee secure cable connections required by the setup, as the space is always tamper-resistant against users.

In another variant, one or more Cable Exit Holes are placed at a desired location on the perimeter of the bottom of the Stand Apparatus, allowing cables to be fed to the outside from the Hollow Core. The Cable Exit Hole(s) can be sized and manufactured differently, based on the number and type of cable(s) that need to be passed through the opening for a particular setup. This is useful when running wires into a drilled hole on a tabletop is strictly prohibited, such as when the mounting surface is a premium material like granite or quartz.

In yet another variant, the Stand Apparatus can be made using flat, extruded surfaces with inexpensive metal-forming techniques—such as, but not limited to, stamping and folding sheet metal. This is critical in applications where cost reduction is a higher priority than aesthetics, as stamping and folding requires little to no tooling costs.

In yet another variant, the Stand Apparatus can be made with rounded shapes, featuring circular or semi-circular cross-sections. This can be done to achieve more aesthetically pleasing designs, but manufacturing these designs with consistent tolerances can become cost prohibitive, due to the high initial tooling costs for using metal forming or plastic molding techniques.

In yet another variant, the Stand Apparatus can be made with curved, aesthetically pleasing shapes while minimizing upfront tooling costs, by using newer manufacturing technologies such as 3D printing. This also allows more complex shapes and designs to be made, superseding typical design and previous cost limitations to prioritize a more aesthetically pleasing design as well as being able to print custom logos or markings on the Stand.

In yet another variant, one or more internal Support Ribs inside of the Hollow Core can be added to improve the rigidity of the Stand Apparatus. This becomes especially important if the part is manufactured using plastic-molding or 3D printing, as these additional supports can significantly increase the part's resistance to bending and other deformations.

In yet another variant, the finished product will result in a seam along an axial edge if the part is manufactured using plastic-molding or 3D printing technology. To minimize the visual impact of this imperfection, the part should be manufactured such that the seam lines up with a Cable Exit Hole, and/or away from the primary user. For example, if the primary user is typically facing the front of the Stand Apparatus, then both the Cable Exit Hole and seam can be placed collinearly on the rear, which visually hides both the exiting cables and the seam from the user for a more aesthetically pleasing usage experience, as users would typically not see the back of the unit. In addition, a decal may be affixed to hide any seams.

In a third aspect of the disclosed subject matter, a VESA-compatible mounting plate, or VESA Plate, which can be attached to the Stand Apparatus, is disclosed.

In one variant, the VESA Plate can be manufactured together with the Stand Apparatus, such as in the case of, but not limited to, plastic molding or 3D printing.

In another variant, the VESA Plate can be manufactured separately as a distinct part. This allows additional benefits, such as, but not limited to, differing the choice of material between the Stand Apparatus and VESA Plate for aesthetic reasons, to reduce costs, and/or to increase the mechanical strength on either of the specific parts, or the overall assembly.

In yet another variant, different VESA Plates can be manufactured and then assembled with the Stand Apparatus, depending on the VESA pattern that needs to be supported, such as, but not limited to, VESA 100×100mm and VESA 75×75mm, or to support a proprietary, non-standard mounting pattern.

In yet another variant, the VESA Plate can be made with a magnetically attachable mounting surface instead of a standard VESA-mounting pattern, to allow for faster device mounting and/or removal.

In yet another variant, the VESA Plate can be made with a Center Thru-Hole, so that the connected VESA-ready device can have its cabling run through the apparatus.

In yet another variant, the VESA Plate can be made with one or more built in, radial Cable Guides, emanating from the Center Thru-Hole. These Cables Guides allow any wire that originates away from the center of the VESA plate to be easily fed back into the hollow core of the Stand Apparatus.

In yet another variant, the VESA Plate can be made sufficiently thick to embed additional power and/or data circuitry inside of the VESA Plate. For example, an inductive coil may be built into the VESA plate to allow mounted devices to be charged and/or have data pass-through magnetically, without the use of any additional wiring or cables.

In a fourth aspect of the disclosed subject matter, an optional adjustable adaptor bracket, or Adjustable Adaptor, which attaches between the Stand Apparatus and VESA Plate, is disclosed. By adding the optional Adjustable Adaptor into the assembly, the VESA Plate may articulate and/or provide pitch, yaw, and tilt adjustments previously not possible.

In one variant, the geometry of the Adjustable Adaptor, VESA Plate, and/or Stand Apparatus interconnecting pieces may be designed to allow the VESA Plate to be adjusted at any time. In its default configuration, a primary user can view the front of the VESA-ready device. This variant would allow them to adjust a tilting mechanism and “flip” the VESA Plate, such that the front of the VESA-ready device is now viewable by a secondary user facing directly opposite of the primary user.

In a fifth aspect of the disclosed subject matter, an optional base plate, or Base Plate, which can be attached to the Mounting Plate, is disclosed. By adding the Base Plate onto the Mounting Plate, the entire assembly can now be free standing and portable, without the need to attach the Mounting Plate onto a fixed desk, countertop, or other table surface.

In one variant, the Base Plate can be manufactured with the Mounting Plate built-in, thus reducing the number of pieces required in the assembly.

In another variant, the Base Plate can be attached to the Mounting Plate via mechanical means—such as, but not limited to, screws, rivets, and other fasteners; or chemical means—such as, but not limited to, adhesives, epoxies, and other compounds.

In yet another variant, the Base Plate can be manufactured with additional void space inside of its volume, to allow the storage of various add-ons, such as extra cables, external battery packs, and other connectivity accessories that may be required by the VESA-ready, electronic device.

In yet another variant, the Base Plate can have a through hole that allows wiring and cabling going through the Thru Hole to exit into its void space. This enables the VESA-ready device to be further enhanced by allowing external accessories to always remain connected while remaining hidden from view—such as, but not limited to, external battery packs to increase tablet “on” time before batteries are depleted, and external cellular or mobile communication modules for pop-up setups or environments where Wi-Fi isn't available.

In a sixth aspect of the disclosed subject matter, an optional plate with a Kensington lock slot, or Optional Kensington Plate, is disclosed. Adding this piece between the Stand Apparatus and Base Plate allows the completed assembly to remain theft-resistant and semi-mobile within a fixed radius, while allowing the apparatus to remain aesthetically pleasing for setups that don't have this requirement.

In one variant, the Optional Kensington Plate's lock slot feature can be directly built into the geometry of the Base Plate. This reduces the number of pieces required and should minimize production costs.

In another variant, the Optional Kensington Plate's lock slot feature can be directly built into the Stand Apparatus. This reduces the number of pieces required and should minimize production costs.

### BRIEF DESCRIPTION

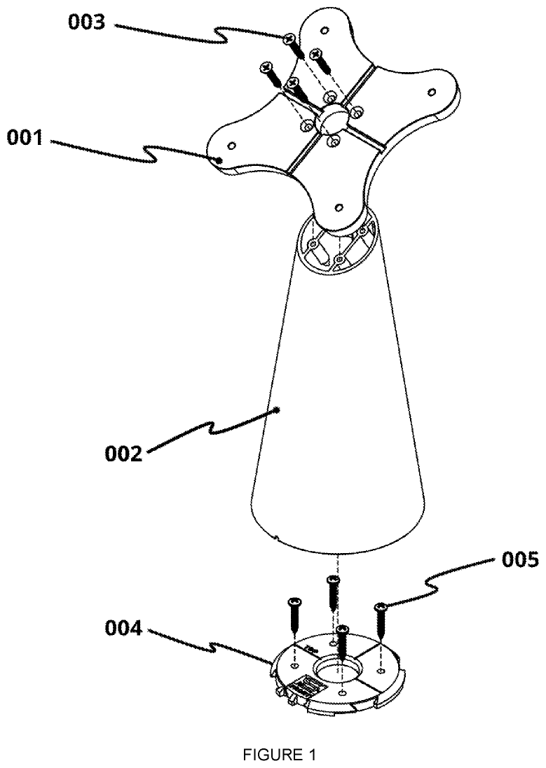

FIG. 1 shows an exploded, front isometric view of an example of the disclosed subject matter's core components in accordance with some implementations.

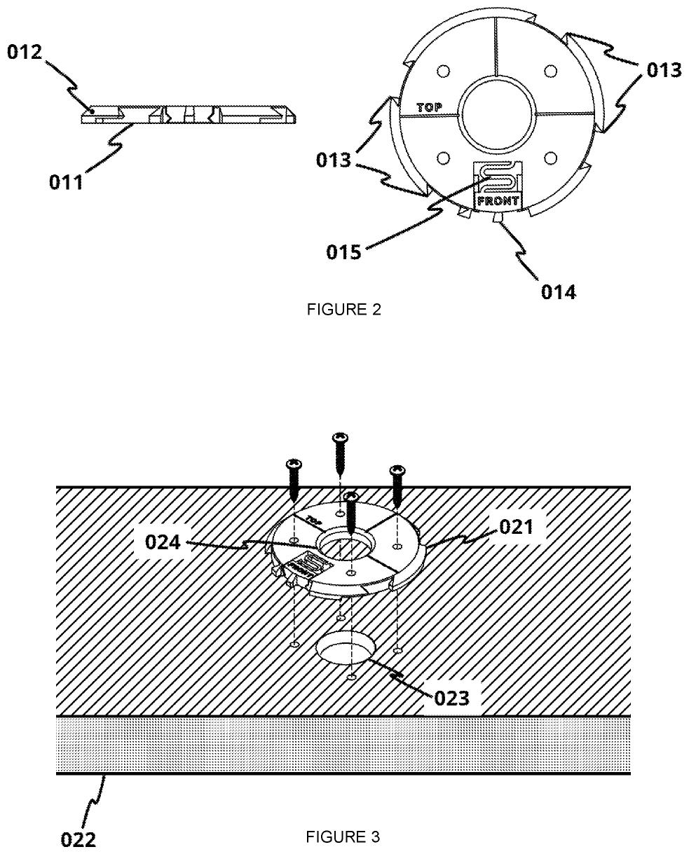

FIG. 2 illustrates orthogonal views of an example Mounting Plate in accordance with some implementations.

FIG. 3 shows the Mounting Plate being installed in accordance with some implementations.

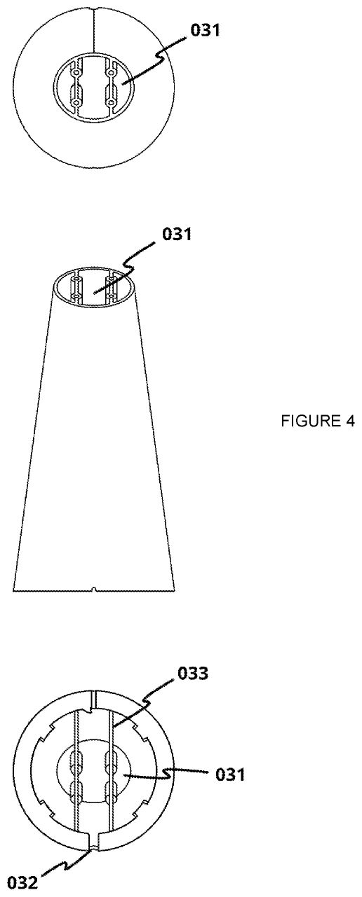

FIG. 4 shows the Stand Apparatus in multiple orthogonal views in accordance with some implementations.

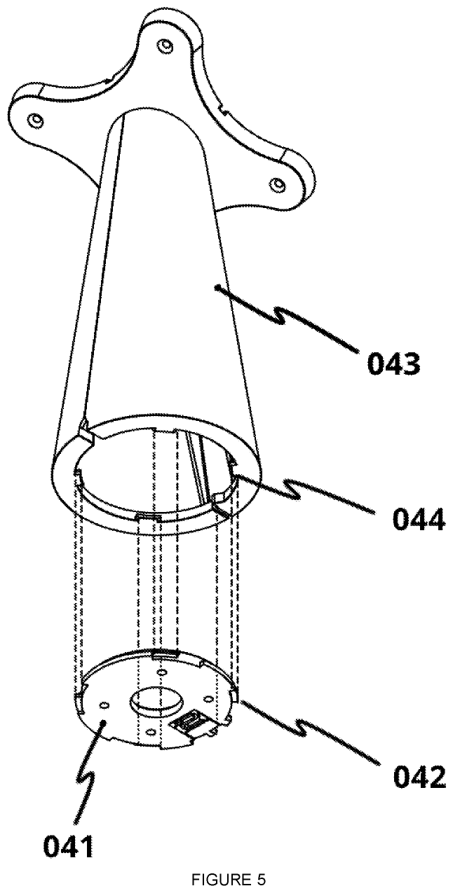

FIG. 5 shows a bottom isometric view of the exploded assembly in accordance with some implementations.

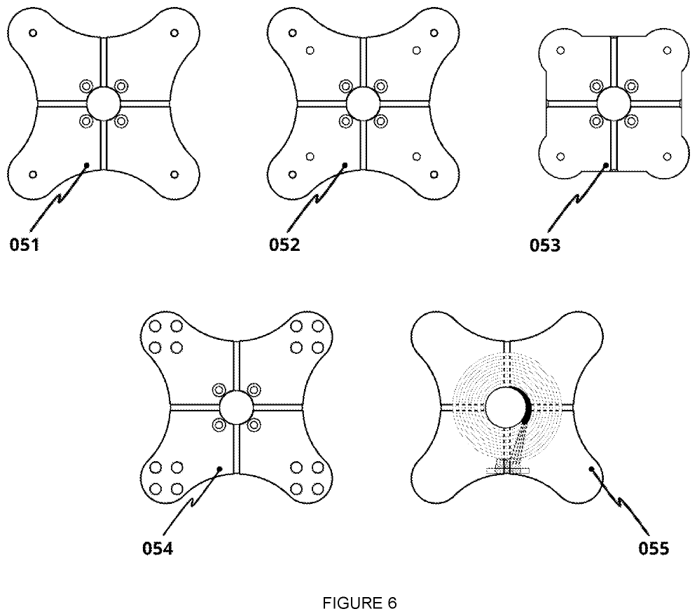

FIG. 6 demonstrates three different VESA Plate options in accordance with some implementations.

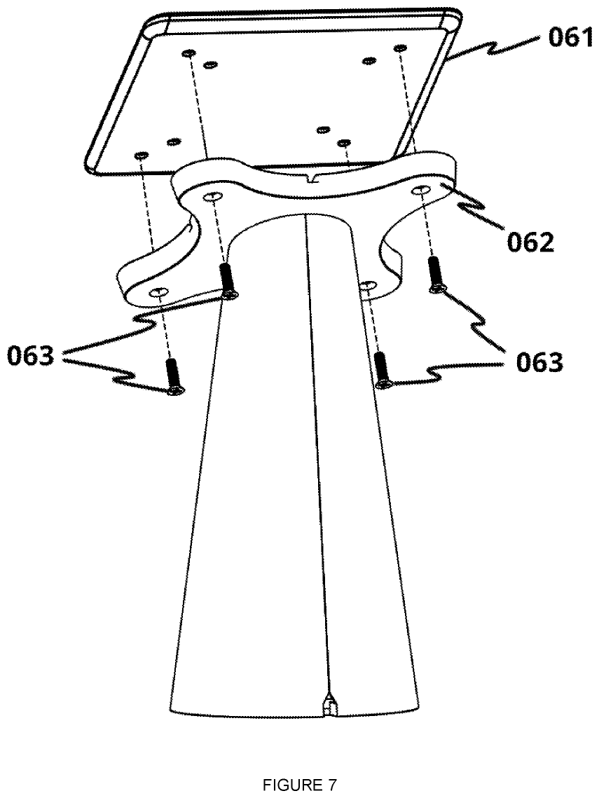

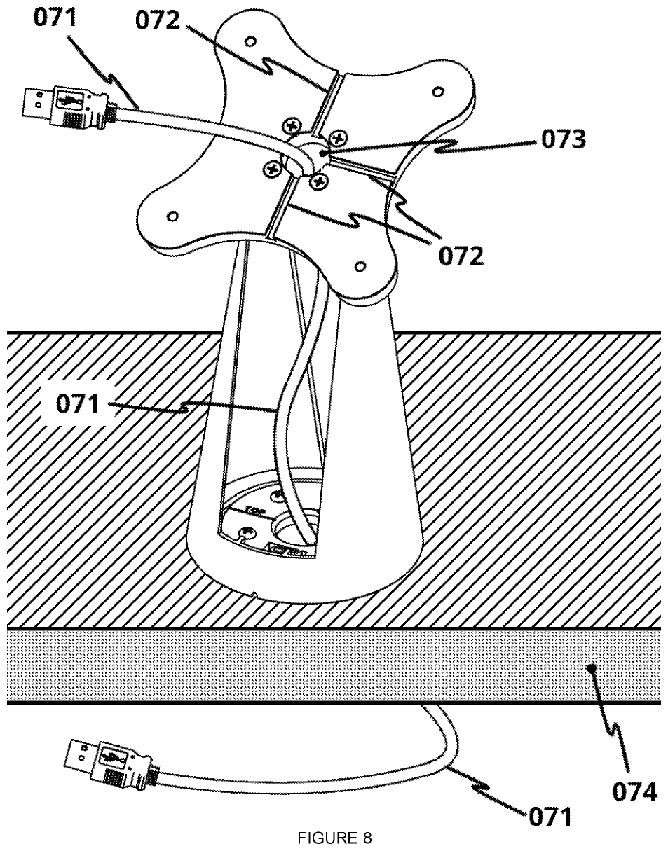

FIG. 7 shows how an example VESA-ready device can be mounted onto the VESA Plate in accordance with some implementations.

FIG. 8 illustrates how a connectivity cable can be run through the VESA Plate's radial Cable Guides in accordance with some implementations.

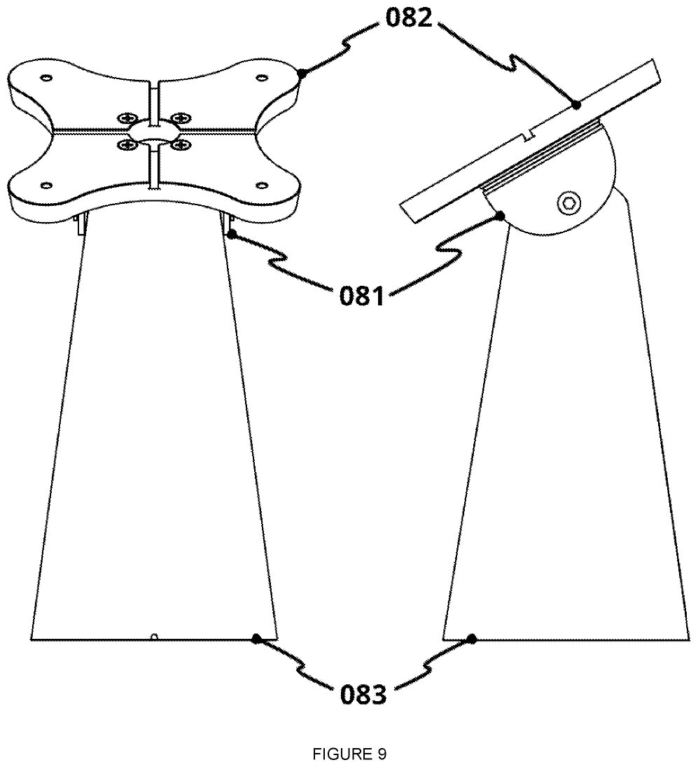

FIG. 9 demonstrates an optional add-on component between the VESA Plate and Stand Apparatus in accordance with some implementations.

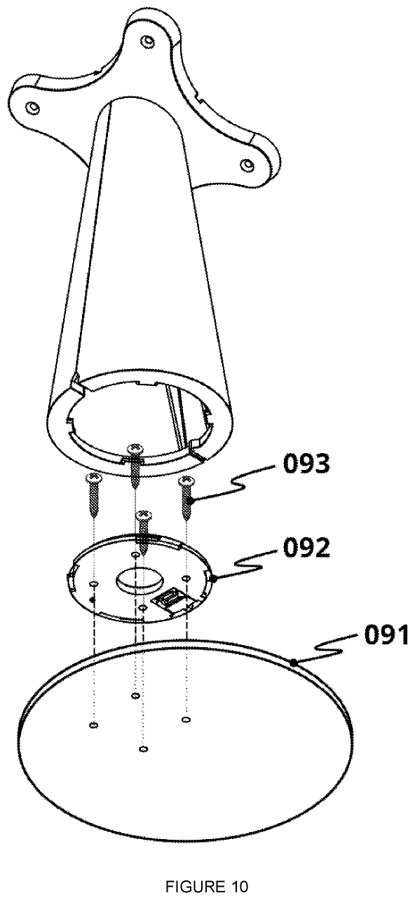

FIG. 10 shows an exploded view of an optional Base Plate in accordance with some implementations.

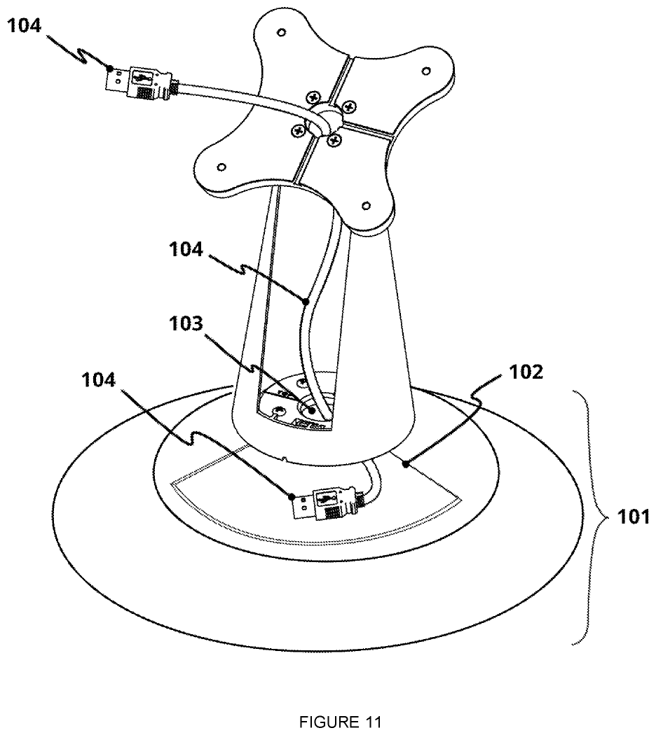

FIG. 11 illustrates an assembled cut-away view of a thicker variant of the optional Base Plate in accordance with some implementations.

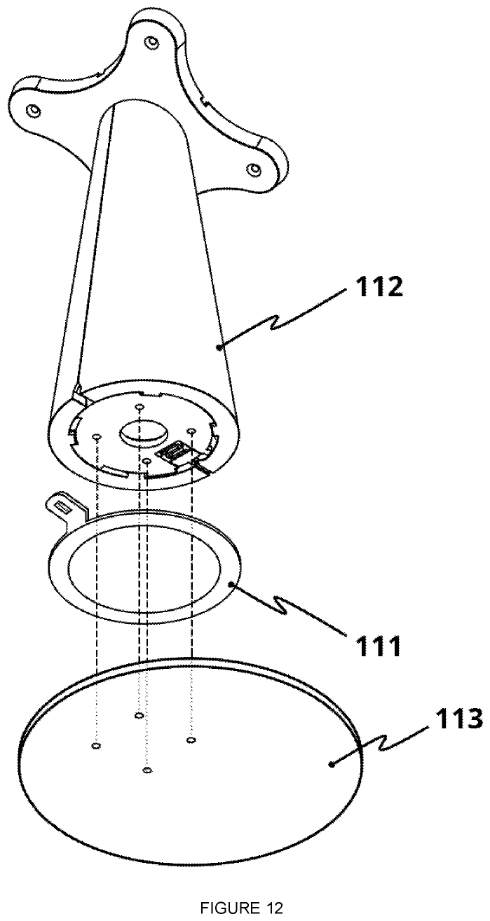

FIG. 12 demonstrates an exploded view of the optional Kensington Plate in accordance with some implementations.

### DETAILED DESCRIPTION

Those of ordinary skill in the art will realize that the following detailed description of the present disclosed subject matter is illustrative only and is not intended to be in any way limiting. Other embodiments of the present disclosed subject matter will readily suggest themselves to such skilled persons having the benefit of this disclosure. Reference will now be made in detail to implementations of the present disclosed subject matter as illustrated in the accompanying drawings. The same reference indicators will be used throughout the drawings and the following detailed description to refer to the same or like parts.

The term “VESA” refers to the VESA Mounting Interface Standard, or colloquially known as VESA Mount, which is a family of standards defined by the Video Electronics Standards Association for mounting flat panel monitors, TVs, and other displays to stands or wall mounts. It is implemented on devices such as, but not limited to, most modern flat panel monitors and TVs. and some specialized tablets designed for mounting.

The term “PoE” refers to Power-over-Ethernet, which is a family of standards defined by the Institute of Electrical and Electronics Engineers (IEEE) standard IEEE 802.3 since 2003, for delivering power over Ethernet wiring. It is implemented on devices such as, but not limited to, most modern Internet Protocol (IP) cameras, Voice-over-IP (VOIP) telephones, Wireless Access Points (WAPs), Point-of-Sale (POS) kiosks, and other computing devices requiring both power and connectivity over a single connected cable.

The term “Kensington Slot” refers to a Kensington Security Slot, where a Kensington lock can be installed; which is a part of an anti-theft system designed and patented by Kryptonite in 1999-2000 with U.S. Pat. Nos. 6,081,974, 6,317,936, and 6,360,405.

FIG. 1 shows an exploded, front isometric view of the disclosed subject matter's core components, with the VESA Plate (001) assembled to the Stand Apparatus (002) using a set of Fastening Hardware (003). These items are aligned with the Mounting Plate (004), which is then affixed to a mounting surface using another set of Fastening Hardware (005).

FIG. 2 illustrates orthogonal views of the Mounting Plate (011). This single part features the combination of a beveled top (012), Unique Geometry (013), and a spring-loaded Retaining Clip (014) for installation with other aspects of the disclosed subject matter. In this design, the spring (015) for the Retaining Clip can be an integrated part of the Mounting Plate, using the same material, molding or 3D printing manufacturing techniques.

FIG. 3 demonstrates the Mounting Plate (021) being installed onto a desk or table surface (022) with a pre-drilled through hole (023), which aligns with a centered Thru Hole (024) on the Mounting Plate. This allows cables and other wiring to be run through the desktop surface.

FIG. 4 shows the Stand Apparatus in multiple orthogonal views. As shown, the cross section is curved for an aesthetically pleasing look. Its Hollow Core (031) allows the installer to run cables and wiring through the part. It can exit out of its hollow bottom, or via a premade Cable Exit Hole (032) on the back of the Stand Apparatus. To improve mechanical strength, Support Ribs (033) are added into the design.

FIG. 5 illustrates a bottom isometric view of the exploded assembly, specifically displaying how the Mounting Plate (041) and the Unique Geometry (042) built into its perimeter matches up with the Stand Apparatus (043) and the Reciprocating Geometry (044) built into its interior perimeter. This design allows a secure, fixed assembly without the use of any externally visible screws.

FIG. 6 demonstrates three different VESA Plate options, with the first design supporting only VESA 100×100 (051), with the center design supporting both VESA 100×100 and 75×75 (052), while the third design supports only VESA 75×75 (053). Other possible options to support quick device removal are demonstrated, where the VESA Plate has a magnetic mounting plate (054), with one or more magnets in place of traditional fasteners for easier removability. The same magnetic or fastener-based design can also feature an inductive coil built-in for charging and/or data transfer (055).

FIG. 7 shows how an example VESA-ready device (061) can be mounted onto the VESA Plate (062), using fastening hardware (063).

FIG. 8 illustrates how a connectivity cable (071) can be run through the VESA Plate's radial Cable Guides (072), then into the Center Thru-Hole (073), through the Stand Apparatus's hollow core, then finally through the desktop surface (074). This design allows all cables to be hidden from view during normal use, thus increasing its tamper resistance.

FIG. 9 demonstrates an optional add-on (081) between the VESA Plate (082) and Stand Apparatus (083), which provides an additional degree in flexibility of movement. When installed, the VESA Plate may now tilt up/down, rotate, and/or swivel left-right.

FIG. 10 shows an exploded view of an optional Base Plate (091), which attaches to the Mounting Plate (092), using fastening hardware (093). This allows the apparatus to operate standalone with no need to drill into a table/countertop surface.

FIG. 11 illustrates an assembled cut-away view of a thicker variant of the optional Base Plate (101), which allows void space (102) to be accessible inside of the Base Plate by way of a coincident slot or hole (103), matching the Thru Hole on the Mounting Plate. This allows VESA mounted electronics' cabling (104) to be connected to peripherals hidden in the void space for additional functionality.

FIG. 12 demonstrates an exploded view of the optional Kensington Plate (111), which is inserted between the Stand Apparatus (112) and optional Base Plate (113). Installing this part allows the stand to be free-standing, yet securable with a tethered Kensington Lock.

All figures included herein demonstrate some of the many possible and various form factors or sizes that the disclosed subject matter can be in. In these variants, the disclosed subject matter can be directly flush mounted onto a wall surface, have its Mounting Plate be affixed to a wall stud, and have an optional add-on installed to provide the design with adjustability to the display angle of the VESA mounted device. To allow the device to standalone without having to affix it to a desk, countertop, or wall; the Mounting Plate can be manufactured to be significantly larger in shape and size, possibly out of higher density materials like metal. This allows the product to be free standing. The height of the Stand Apparatus can also be made significantly taller, to eliminate the need to place the disclosed subject matter onto another piece of furniture to display the VESA mounted device at a user-friendly height. To secure the disclosed subject matter with the aforementioned modifications, a Kensington Lock Slot can be added to the base piece or via a modular add-on between the Mounting Plate or Base Piece and utilized to prevent unauthorized removal. The disclosed subject matter's variable designs and manufacturing options available allow changes to be made before production for additional functionality, and the descriptions and figures shown herein simply show some examples of possible configurations but should not be construed as a limit on potential embodiments.

It is contemplated that any optional feature of the inventive variations described may be set forth and claimed independently, or in combination with any one or more of the features described herein. Reference to a singular item includes the possibility that there is a plurality of the same items present. More specifically, as used herein and in the appended claims, the singular forms “a,” “an,” “said,” and “the” include plural referents unless specifically stated otherwise. In other words, use of the articles p for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present disclosed subject matter is not to be limited to the examples provided and/or the subject specification, but rather only by the scope of the claim language. Use of the term “disclosed subject matter” herein is not intended to limit the scope of the claims in any manner. Rather it should be recognized that the “disclosed subject matter” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Disclosed subject matter, etc.) be accorded special significance in describing the disclosed subject matter relative to another or the claims. All references cited are incorporated by reference in their entirety. Although the foregoing disclosed subject matter has been described in detail for purposes of clarity of understanding, it is contemplated that certain modifications may be practiced within the scope of the to-be appended claims.

What is claimed is:

1. An apparatus comprising:
a mounting plate disposed parallel to a surface where the apparatus is expected to be placed, wherein the mounting plate includes a unique geometry to permit other parts to be assembled onto the mounting plate and be secured against removal, without the use of any external screws or other visible hardware, and wherein the apparatus is more aesthetic when fully assembled, as there are no hardware pieces visible to a primary user.
